(19) United States
(12) Patent Application Publication
(10) Pub. No.: US 2015/0213214 A1
(43) Pub. Date: Jul. 30, 2015

(54) SYSTEM AND METHOD FOR FACILITATING COMMUNICATION WITH COMMUNICATION-VULNERABLE PATIENTS

(71) Applicants: Lance S. Patak, San Diego, CA (US); Bryan James Traughber, Shaker Heights, OH (US)

(72) Inventors: Lance S. Patak, San Diego, CA (US); Bryan James Traughber, Shaker Heights, OH (US)

(21) Appl. No.: 14/609,751

(22) Filed: Jan. 30, 2015

Related U.S. Application Data
(60) Provisional application No. 61/933,679, filed on Jan. 30, 2014.

(51) Int. Cl. G06F 19/00; G06F 3/0482; G06F 3/0481; G06F 3/16

(52) U.S. Cl. CPC G06F 19/3406; G06F 3/167; G06F 3/0482; G06F 3/04817

(57) ABSTRACT

A system for facilitating communication with communication-vulnerable patients is disclosed. A plurality of objects in the form of images and/or words representing patient conditions and/or desires is displayed on an electronic display utilizing a computer program. An object is selected using electronic means, resulting in a word or phrase corresponding with the selected object being audibly transmitted through a speaker and/or a phrase or sentence being automatically generated and displayed on the electronic display so as to communicate the patient's condition or desire to a caregiver.

### RELATED APPLICATION

This application claims priority to U.S. Provisional Application Ser. No. 61/933,679, filed on Jan. 30, 2014.

This invention was made with government support under Federal Grant Number R41NR014087 awarded by the National Institutes of Health, National Institute of Nursing Research. The government has certain rights in the invention.

### BACKGROUND OF THE INVENTION

The present invention is generally directed to computer implemented devices and methods and the medical field. More particularly, the present invention relates to a system and computer implemented method for facilitating communication between a patient and his or her medical provider or family member.

More than 2.7 million intensive care unit (ICU) patients in the United States each year are unable to speak, in large part, because of the presence of artificial airways and mechanical ventilation. Other communication-vulnerable patients include those with limited native language proficiency or those who are hearing-impaired, aphasic, etc. Communication-vulnerable patients can experience extreme frustration, panic, anxiety, sleeplessness, fear, frustration, isolation and insecurity when ineffectively attempting to communicate.

Communication disability is a significant factor contributing to adverse patient outcomes, such as physical restraint, misinterpretation of pain and symptoms, and medication and treatment errors during acute care hospitalization. Without effective communication, communication-vulnerable patients' needs often go unrecognized and unfulfilled, which may prolong mechanical ventilation as well as length of ICU and hospital stay, resulting in an increased incidence of ventilator associated pneumonia, days in delirium, and healthcare costs. In addition, other problems arise due to the insufficient communication from the patient, such as misdiagnosing localized areas of pain, which can result in over-medication generally or the medication of an area which is not the source of pain. Proper and essential treatment given in an adequate and timely manner will help resolve or prevent many post-operative complications and decrease the patient's length of stay in the hospital.

For many years, communication boards have been used to assist patients with communicating their needs when they cannot speak, write, or otherwise effectively communicate. One such communication board is sold under the trademark EZ Board, which is the subject of U.S. Pat. No. 6,442,875. Experimental research has demonstrated that post-operative cardiac surgical patients who received communication boards reported significantly higher satisfaction than those who received the usual care. While such communication boards have been shown to improve communication between nurses and impaired patients, many patients are still under served because hospitals limit the number of non-English versions of the communication board they keep on hand. Also, such communication boards have shortcomings, which negatively impact the use thereof, including the fact that the communication boards are prefabricated and cannot be personalized. Moreover, such communication boards can be visually complex and some patients require more focused, single-page options. Moreover, such communication boards only enable the communication-vulnerable patient to point to a printed word or image. The individual, such as the caregiver, that the message is intended for must see that the patient is utilizing the communication board, and be at a position and angle so as to clearly see what the patient is pointing to as far as a word or symbol and then attempt to interpret what the patient's condition or desire is from that single word, short phrase or image that is being pointed to.

Accordingly, there is a continuing need for a system and method, which is appropriate to address healthcare needs of communication-vulnerable patients and overcome previous drawbacks and shortcomings. The present invention fulfills these needs, and provides other related advantages.

### SUMMARY OF THE INVENTION

The present invention resides in a system, and related method, for facilitating communication with communication-vulnerable patients. The invention resides in a computer program, which provides a graphical user interface having objects relating to predetermined patient conditions and desires. A computer having non-transitory memory for storing the computer program, and a processor for operating and executing the computer program, is operably connected to an electronic display. Means are provided for the patient to electronically select an object on the display. An algorithm generates a word, phrase or sentence for responding to the selected object and automatically generates a phrase or sentence incorporating the word or concept of the selected object and transmits the generated word, phrase or sentence through a speaker to communicate the patient's selection.

In a particularly preferred embodiment, the electronic display comprises a touchscreen, such as that of a hand-held tablet or smartphone. The means for electronically selecting an object may comprise a touchscreen, electronic remote control device, keyboard, toggle switch, finger pad, stylus, or eye gaze technology.

In one embodiment, the computer software program enables language selection from a plurality of languages, whereby objects containing words and text generated are displayed and/or audibly transmitted in the selected language. The computer program also enables a second language selection, whereby words or phrases generated corresponding to a selected object are displayed and/or audibly transmitted in the selected two different languages.

The computer software program may be configured to display selectable objects relating to common patient responses to caregiver queries, patient conditions, patient desires and patient questions to caregivers. The selectable objects can be selectively altered manually. Alternatively, the selectable objects can be altered automatically by the computer program based on commonly used objects by the patient over time.

The computer software program is configured to provide a plurality of link icons representing general patient conditions or desires. The selection of a link icon results in a display of one or more pages of selectable objects relating to more specific patient conditions or desires relating to the general patient condition or desire selected link icon. The link icons comprise buttons having the patient conditions and desires, such as “I Am”, “I Want”, “Pain Area” and “Pain Scale”.

The computer software program provides a page having a graphical representation of a human body with selectable body parts and objects representing common body ailments. The computer program is configured to generate and visually display and/or audibly transmit a phrase or sentence corresponding to the selected body part and ailment object.

The computer program is also configured to provide a pain scale having a selectable range of patient pain indicia. The computer program is also configured to provide a plurality of pain state related selectable objects and a selectable request for pain medication in connection with the pain scale.

The computer program may be configured to provide at least a portion of a page that enables the patient to write or draw using the patient's finger, hand-held object, a computer mouse, switch toggle, finger pad or eye gaze technology.

The computer program may be configured to display an electronic keyboard and selectable objects representing commonly used words or phrases to begin a sentence, and a text box in which the phrase or sentence generated by the selection of the objects and/or keys of the keyboard is visually displayed. The computer software program may include a text-to-speech generator algorithm for transmitting the phrase or sentence generated in the text box audibly through the speaker. The computer program includes a text-to-speech generator algorithm for transmitting the phrase or sentence generated in the text box in two different languages, providing bilingual communication in text format and/or audible voice through the speaker.

In accordance with the method of the present invention, a non-transitory computer-readable medium for facilitating communication with a communication-vulnerable patient, comprising instructions stored thereon, that when executed on a processor, performs the steps of displaying on an electronic display a predetermined plurality of electronically selectable objects in the form of images and/or words or phrases representing patient conditions and/or desires, generating an audio file comprising a word or phrase corresponding to a selected object, and audibly transmitting through a speaker the word or phrase corresponding to the selected object.

A sentence or phrase may be automatically generated from an object selected by the patient, and visually displayed on the electronic display and transmitted through the speaker.

A selection of languages is provided, and the objects are displayed in the selected language. Moreover, the word or phrase corresponding to the selected object is transmitted through the speaker in the selected language. Moreover, phrases or sentences generated corresponding to the selected object are displayed in the selected language on the electronic display. A second, different language may be selected, wherein the word or phrase corresponding to the selected object is transmitted in the two different selected languages and/or visually displayed in the two different languages on the electronic display.

Predetermined selectable objects representing common patient conditions, desires, responses to caregiver queries, and/or patient to caregiver queries are displayed on the electronic display. A plurality of link icons may also be displayed on the electronic display which represent general patient conditions or desires. Selecting a link icon automatically links to at least one electronic page having a plurality of objects relating to the general patient condition or desire of the selected link icon.

An image of a human body is displayed on the electronic display with selectable body parts and a plurality of objects representing common body ailments. A phrase or sentence is automatically generated when a body part and body ailment object are selected, and the generated phrase or sentence is visually displayed on the electronic display and/or audibly transmitted.

A pain scale may be displayed on the electronic display having a range of patient pain indicia. In addition to the pain scale, a plurality of pain state related objects and a request for pain medication may be displayed in association with the pain scale.

The computer program enables the user to modify the content of the objects or the arrangement or order in which the objects are displayed. Moreover, the computer program may import new or updated objects from a remote electronic source, such as the Internet, another software application, or the like.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective and environmental view of a patient holding an electronic tablet and selecting a patient condition or desire object using a touchscreen of the device, and the audible transmission of a corresponding word or phrase through a speaker of the device, in accordance with the present invention;

FIG. 2 is a top plan view of the device and a home page, in accordance with the present invention;

FIG. 3 is a top view similar to FIG. 2, illustrating the selection of a settings dialog box, in accordance with the present invention;

FIG. 4 is a top view of the electronic device illustrating the home page in a selected language of Spanish, in accordance with the present invention;

FIGS. 5 and 6 are top views of an electronic device running a computer program of the present invention and illustrating objects relating to an “I Am” general patient condition selected link icon.

FIGS. 7-9 are top views of an electronic device displaying a plurality of selectable objects corresponding to a “I Want” general patient desire selected link icon, in accordance with the present invention;

FIGS. 10 and 11 are screen shots of an electronic device, illustrating a subcategory of selectable objects relating to patient desires;

FIG. 12 is a top view of an electronic device and a screen shot of front and rear images of a human body and corresponding body ailment objects, in accordance with the present invention;

FIGS. 13 and 14 are top views of an electronic device displaying screens relating to a patient pain scale and pain-related selectable objects, in accordance with the present invention;

FIG. 15 is a top view of an electronic device displaying a freestyle draw screen, in accordance with the present invention; and

FIG. 16 is a top view of an electronic device displaying a screen having a text box, an electronic keyboard, and selectable objects for creating sentences.

### DETAILED DESCRIPTION OF THE PREFERRED EMBODIMENTS

As shown in the accompanying drawings, for purposes of illustration, the present invention is directed to a system and method for facilitating communication with communication-vulnerable patients. The communication-vulnerable patients may be voice-disabled patients, such as those on mechanical ventilation, those that are hearing-impaired, aphasic or the like. Alternatively, the communication-vulnerable patient may be a patient who speaks a foreign language as compared to the native language of the country or area where the patient is being treated.

In the past, such communication has involved, to a large extent, the nodding of one's head, gestures, and/or writing on paper and the like. However, in accordance with the present invention, a computer implemented computerized program has selectable objects which can be made via a display screen, the selections textually and/or graphically represented on the display screen and audibly announced or a combination of visual and audible presentation so as to communicate the patient condition and desires to the caregiver. The selections, requests, instructions, etc. can also be made in more than one language.

More particularly, the present invention is typically embodied in a computer program which is computer enabled so as to operate on a computer having a processor and memory for operating the computer program, an electronic display screen, means for electronically selecting objects of a graphical user interface provided by the computer program, and a speaker for audibly transmitting words, phrases, sentences, and the like generated in accordance with the present invention. Such a computerized system should be configured and designed so as to be operable by a communication-vulnerable patient, such as in a hospital or care facility setting or the like.

The present invention contemplates an electronic display screen which is physically separate from the associated computer, but in electronic communication therewith. Objects on the graphical user interface could be selected by a variety of means, including use of a computer mouse, a manual toggle or switch apparatus, such as those used frequently in assisted augmentation communication (AAC) which could interface with the invention, which could be used for individuals who can move their hands or fingers but not their arms and thus would enable the patient to utilize a toggle, mouse, switch, etc. to make the various selections without touching a display screen or manipulating a keyboard and while the display screen is positioned conveniently so as to be easily viewed while this is performed. Alternatively, the present invention could be incorporated into a computer device wherein the device is in the form of a display screen which may be held on an arm which is pivotable and movable towards and away from the patient and which may comprise a touchscreen and may incorporate a computer and the necessary electronics therewith, or be wired or wirelessly connected to a computer which runs the software embodying the present invention.

It is contemplated by the present invention that those patients who do not have use of their hands and/or fingers, that “eye gaze” technology be incorporated such that the patient can make menu, button, link, etc. selections by merely fixating his or her gaze on a particular object on the screen for a predetermined period of time, and the computerized device being able to determine the prolonged gaze and make that selection in connection with known software used for this purpose.

However, in a particularly preferred embodiment, the computer program embodying the present invention operates on a hand-held electronic device 10, such as a tablet, smartphone or the like, having a touchscreen display 12 operably connected to an internal computer having a processor and memory for operating the computer program, and a speaker for audibly transmitting information. Of course, the present invention could be incorporated into a device, which is specially constructed for the purposes of the invention.

It will be appreciated by those skilled in the art that the computer program of the present invention may be stored on a non-transitory computer-readable medium for facilitating communication with a communication-vulnerable patient, comprising instructions stored thereon, that when executed on a processor performs the steps of the invention. The non-transitory computer-readable medium may include a hard drive, compact disc, flash memory, volatile memory, magnetic or optical card or disc, machine-readable disc, such as CD ROMS or the like, or any other type of memory media suitable for storing and retrieving and operating such a computer program, but does not include a transitory signal per se. In one embodiment, as illustrated, the present invention is embodied in a computer program software application, which is downloadable to a hand-held device 10 such as an electronic tablet having a touchscreen 12 or the like and a computer with memory and a processor.

As will be more fully illustrated and described herein, the computer program of the present invention, used in conjunction with the computerized system, such as the hand-held tablet 10, is usable by the patient to communicate with his or her medical care providers (such as nurses, doctors, etc.) and family members and loved ones when in a communication-challenged condition such as when being intubated, speaking a different language than the medical care providers, etc. The invention enables the patient to select words, phrases, instructions, requests, etc. and have these conveyed to the family member or medical provider. In a particularly preferred embodiment, the invention both visually displays these requests and audibly announces the requests or instructions, etc. Multiple languages may be selected such that the patient and medical care provider can both benefit from the device as the patient selects words, phrases, requests, etc. which are then translated and displayed and/or verbally announced to the medical care provider in another language.

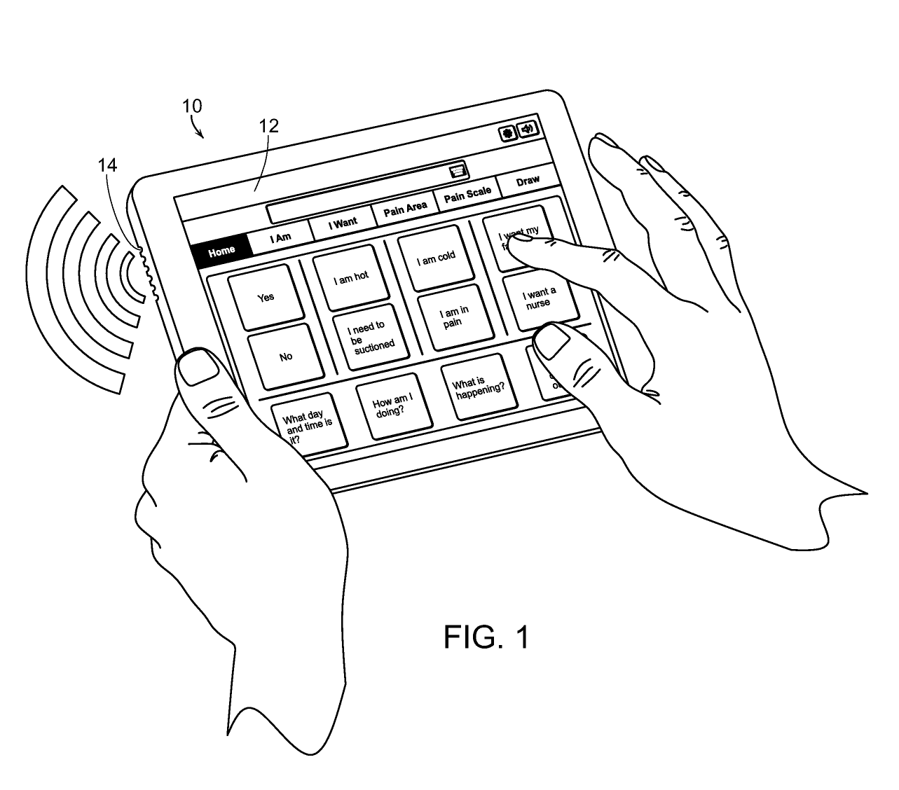

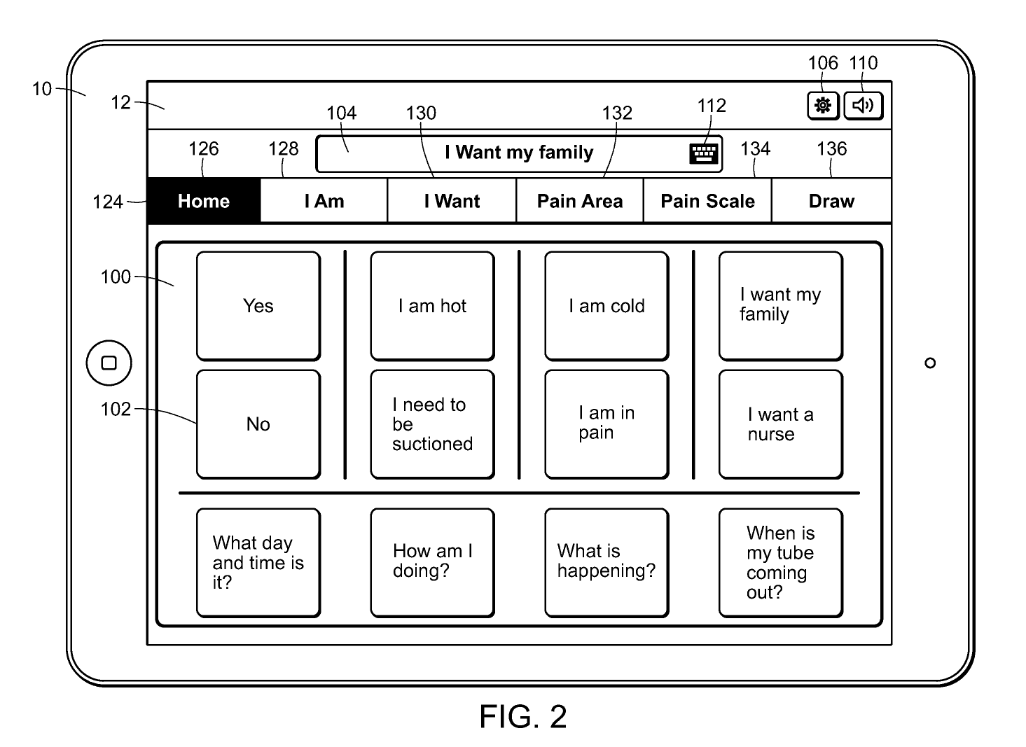

With reference now to FIGS. 1 and 2, after the computer program has been installed on the computer, illustrated herein as a hand-held tablet 10 with a touchscreen 12, as described above, the internal circuitry of the computer, including the processor and memory where the computer program resides, is used to operate the computer program and provide a graphical user interface on the display screen 12. The graphical user interface has a plurality of objects, icons, and the like relating to predetermined patient conditions and desires, and means are provided for the patient to electronically select an object, icon, etc. on the display. In the embodiment illustrated herein, the tablet 10 has a touchscreen 12, which enables the patient to electronically select an object of the graphical user interface by touching the touchscreen on the display immediately above the object.

With particular reference now to FIG. 2, a “Home” page 100 is shown having a plurality of selectable objects 102 in the form of buttons or boxes having a word or phrase therein. These selectable objects 102 relate to common patient responses to caregiver queries (such as “Yes” and “No”), patient conditions (such as, for example, “I am hot”, “I am cold”, “I am in pain”), patient desires (such as, for example, “I want my family”, “I want a nurse”, and “I need to be suctioned”), and common patient questions to caregivers (such as, for example, “What day and time is it?”, “How am I doing?”, “What is happening?”, and “When is my tube coming out?). Upon first use of the computer program, predetermined common patient responses to caregiver queries, patient conditions, patient desires, and patient questions to caregiver objects are presented to the patient. However, it is contemplated by the present invention that the objects 102 on the home page 100 can be automatically altered based on commonly used objects by the patient over time. Alternatively, the patient can selectively manually alter the objects 102 presented on the home page 100, such as by replacing objects on the home page with other objects on other pages, adding objects, creating new objects, etc.

In accordance with the present invention, when an object 102 is selected by the patient, an algorithm within the computer program generates a word, phrase or sentence corresponding to the selected object and audibly transmits the word, phrase or sentence through the speaker 14 of the device 10 to communicate the patient's condition or desire to a nearby caregiver. The software program may include a text-to-speech generator algorithm for transmitting the word, phrase or sentence audibly through the speaker 14. Other alternatives include providing a database of words, phrases and sentences which are associated with each object, such that when a patient selects an object 102 the word, phrase or sentence corresponding to that object or combination of selected objects is audibly transmitted through the speaker 14. Thus, for example, referring to FIG. 2, if the object “I want my family” is selected, such as by the patient touching the touchscreen 12 immediately above the object incorporating this phrase, this phrase will be audibly transmitted through the speaker 14 of the device 10 so that those caregivers within earshot of the patient will be able to quickly and easily ascertain the patient's desire to see his or her family.

In accordance with an embodiment of the present invention, the computer program includes an algorithm that automatically creates a phrase or sentence relating to an object selected by the patient. Thus, for example, with continuing reference to FIG. 2, if the patient were to select the “I want my family” object 102, that phrase would automatically be generated in a text box 104 on the home page. In this manner, the patient can see that the correct object has been selected. Moreover, caregivers and others assisting the patient will also be able to read the phrase or sentence within the text box 104. In some cases, the entire word or phrase within the object 102 will be all that is generated within the text box 104. However, in other cases, the word or short phrase within the object 102 is not a complete phrase or sentence, and instead the software algorithm creates a more complete phrase and sentence relating to the object selected by the patient. This may be done, for example, by associating a listing of phrases and sentences in a database, which correspond to each object or combination of objects.

Creating a truncated system of words and phrases enables more words and phrases to be associated with objects 102 on a single screen at a time, and also enables these truncated words and phrases to be larger and more easily viewed in the displayed objects. It will also be appreciated that although various selectable buttons or boxes are illustrated in these figures which contain various words and phrases, these words and phrases can be changed as needed.

Moreover, the words or phrases associated with the objects 102 may be replaced with universally recognized symbols, illustrations or the like which relate to these words and phrases. For example, the word “cold” can be associated with an ice cube, snow or the like such that the patient readily recognizes at least one of the image and/or the phrase or word, which conveys that meaning. This is helpful, for example, with patients who are very young and/or do not read or write. In that case, when pressing the object 102 in the form of an image of an ice cube, snow or the like to represent “cold”, the system of the present invention will automatically generate a phrase or sentence corresponding with this object and audibly transmit the generated phrase or sentence through the speaker 14 and/or generate a text phrase or sentence in the text box 104.

As discussed above, although in this disclosure the preferred embodiment is the use of a hand-held computerized device having a touchscreen for selecting an object or the like from the graphical user interface displayed on the electronic display, it will be understood that other such data entry and object selecting methods and devices may be used, such as joysticks, keyboards, mouses, electronic styluses, etc. For example, the computer program of the present invention may be stored and executed on a remote server or on a computer in the hospital, care facility, or patient's room. The server or local computer may provide the graphical user interface on a electronic display, such as a television, and the patient may be provided a mouse, joystick, keyboard, finger pad, or other electronic pointer device for selecting the objects, icons, etc. displayed on the electronic display or television. Any of these devices can serve as the means for selecting an object, icon, key of an electronic keyboard, etc. of the graphical user interface displayed on the electronic display to operate and effectuate the invention. Such selection means may even comprise an electronic device which is incorporated into the bed of the patient and which enables the patient to make selections on the electronic display within the patient's room.

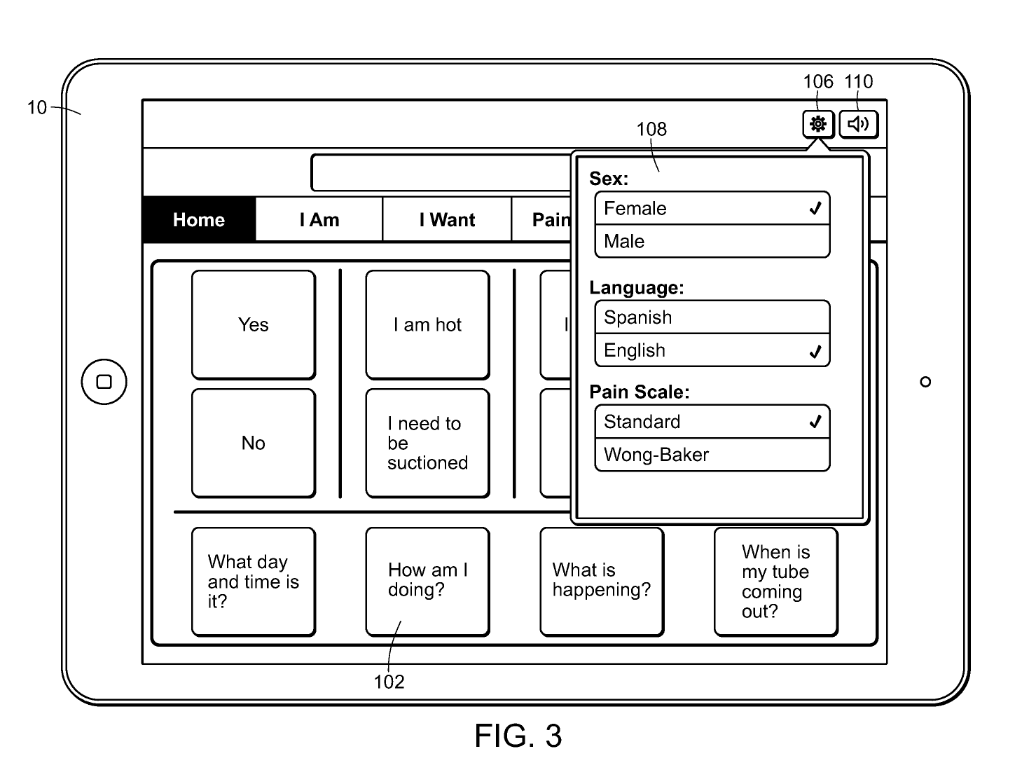

With reference now to FIGS. 2 and 3, a settings icon 106 is displayed on the graphical user interface and electronically selectable so as to open a settings menu box 108. The settings menu box includes a variety of selectable settings, such as the sex of the patient, the language of the patient, and the desired pain scale, etc.

Selection of the sex of the patient can serve to alter the electronically generated voice, which audibly transmits the words, phrases and sentences through the speaker 14. Moreover, selection of male versus female may also present a different set of objects with respect to the patient conditions, desires, etc. Selection of male versus female may also present a different graphical representation of a human body.

The software of the present invention enables language selection, whereby objects containing words and text generated are displayed and/or audibly transmitted in the selected language. Thus, for example, selecting Spanish instead of English in the settings menu 108 will result in the various words and phrases associated with the various icons and objects and the like to be displayed in the selected language. This enables the system of the present invention to be utilized in areas of the country, which predominantly speak different languages, or within different countries which speak different languages. Although Spanish and English are shown for exemplary purposes, it will be understood that a wide variety of languages can be programmed into the software such that a variety of languages can be selected.

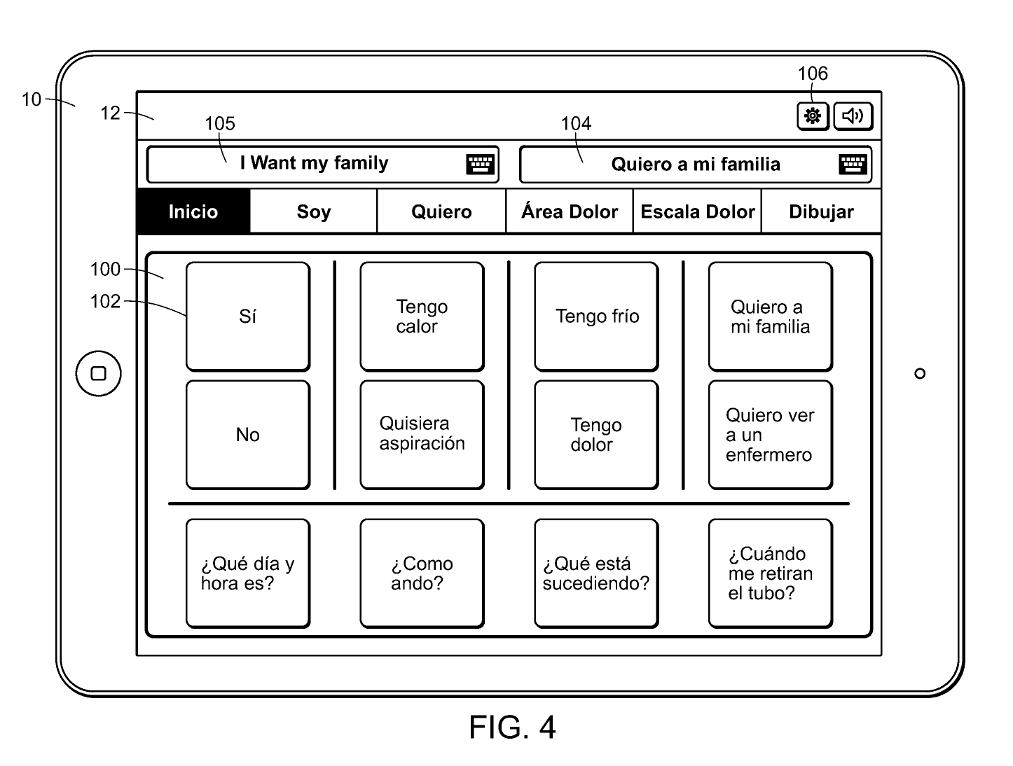

With reference now to FIG. 4, the home page 100 is shown with the objects 102 displayed in Spanish, after Spanish has been selected in the settings menu 108. Thus, when an object is electronically selected by the patient, that word, phrase, or generated phrase or sentence corresponding with the object is audibly transmitted in Spanish. Moreover, the software of the present application may generate the word or phrase associated with the object 102, or generate a more complete phrase or sentence from the word or phrase within the object 102 in the text box 104.

It is also contemplated by the present invention that a primary and secondary language selection may be made. For example, the primary language may represent the language that is predominantly spoken in the area or country, and which most likely the caregivers, such as doctors, nurses, etc., will speak. The secondary language is different than the primary language and may be the language that is spoken by the patient, for example. Thus, for example, a Spanish-speaking patient in the United States may select the secondary language, such as in the settings menu 108 to be Spanish. However, two text boxes 104 and 105 will be generated and displayed on the screen, one text box 104 displaying a generated word, phrase or sentence corresponding with the object 102, which the patient has selected. However, the second text box 105 generates a corresponding word, phrase or sentence as that generated in text box 104, but in the primary language, in this case English. In this manner, the word, phrase or sentence is displayed in both the primary and secondary languages on the display screen 12. Furthermore, the word, phrase or sentence, which is generated may be audibly transmitted in both the primary and secondary language such that the patient, the patient's family and friends, and caregivers can all hear and understand the patient's condition or desire in the language which they speak and understand.

It will be appreciated that the primary and secondary language may be different than English and Spanish. For example, the primary language may be selected as being German, such as when the device is used in Germany, and the secondary language may be Italian, Chinese, etc. Thus, the caregiver, such as the hospital or facility owning the device 10 may set a preferred primary or secondary language. The patient may select a different language that represents the language he or she speaks or the language understood by friends or family members, for example. Of course, in the case where both the patient and the medical care providers and family speak the same language, only a primary language may be selected, such as English for example, such that the phrases are input into the text box and audibly announced in only one language.

It will be seen in the various figures, including FIG. 2, that a selectable volume control button 110 is provided wherein the user can depress or otherwise electronically select this button 110 on the graphical user interface of the display screen and selectively adjust the volume of the speaker 14. This may be done, for example, to lower the volume of the device 10 when in a room having multiple patients so as not to disturb the other patients. However, in other instances where there is a fair amount of commotion or noise, the volume adjustment icon 110 can be used to increase the volume of the speaker 14 of the device 10.

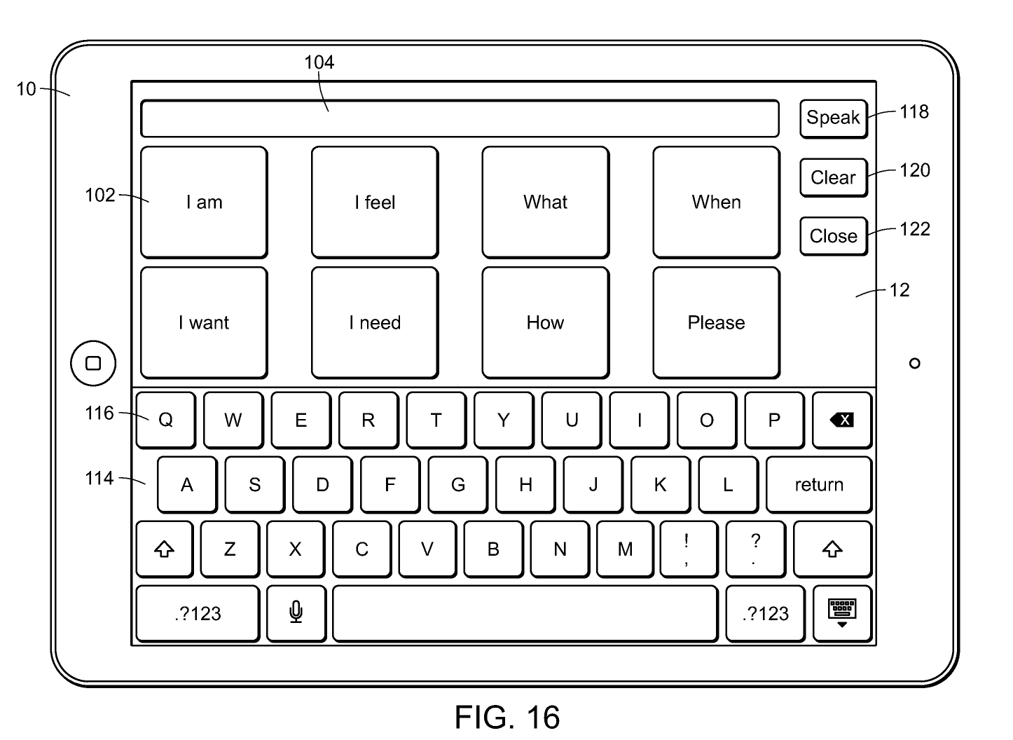

With reference now to FIGS. 2 and 16, a selectable keyboard icon 112 may also be displayed, such as in or adjacent to the text box 104 which will link to a page having an electronic keyboard 114, in the case of a system which does not have a physical keyboard and instead relies upon a touchscreen or the like. It will be understood that if the system includes a physical keyboard, instead of an electronic keyboard 114 being displayed, such as illustrated in FIG. 16, a larger text box 104 may be displayed for the user to enter his or her own selection of words, phrases and sentences using the keyboard. Of course, an electronic keyboard 114 could also be presented, such that the patient could utilize a joystick, mouse, etc. to select the individual keys of the electronic keyboard 114.

With continuing reference to FIG. 16, it is contemplated by the present invention that objects 102 comprising words and phrases which commonly begin or are used in sentences in the communication-vulnerable patient setting also be supplied on the screen so that the patient could easily select one or more of these objects and complete the remainder of the sentence using the electronic keyboard 114. When completing the phrase, sentence, etc. the patient could depress a “speak” icon or button 118 which would cause the typed word, phrase or sentence to be generated audibly, such as through a text-to-speech generator algorithm or the like, and be transmitted through the speaker 14. A typed word or phrase or the like could also be cleared, such as by selecting button or object 120, such as in the instance that the patient changes his or her mind or no longer needs to communicate that phrase or sentence. The entire screen could be closed and returned, for example, to the “Home” page 100 by depressing a close button or icon 122 or the like.

It will be appreciated by those skilled in the art that the communication system and device of the present invention can not only be used by the patient to communicate with his or her caregivers, family members and friends, but also the caregiver communicating with the patient. For example, in cases where the patient is deaf, cannot hear clearly due to age or trauma, or speaks a different language than the caregiver, the caregiver can utilize the system of the present invention to communicate with the patient. The caregiver, for example, could utilize the screen illustrated in FIG. 16 to create words, phrases and sentences which may be visually displayed in the text box 104 and audibly transmitted through the speaker 14 to communicate information, instructions, or query the patient. When in a multi-language mode, as shown above with respect to FIG. 4, such words, phrases and sentences can be displayed in a primary language as well as a secondary language and also audibly transmitted in both languages to enable the caregiver and patient to communicate with one another.

With reference again to FIG. 2, on the home page screen 100, a navigation icon bar 124 is displayed having a plurality of selectable icons, which when selected open one or more new pages corresponding to that icon. In the illustrated embodiment, a selectable icon 126 is provided for “Home”, which when electronically selected will result in the home screen 100 being displayed, as shown in FIG. 2. However, other link icons may be included which will relate and represent general patient conditions or desires, such as selectable icons 128 for the general patient condition of “I Am” and the selectable icon 130 for the general patient desire “I Want”.

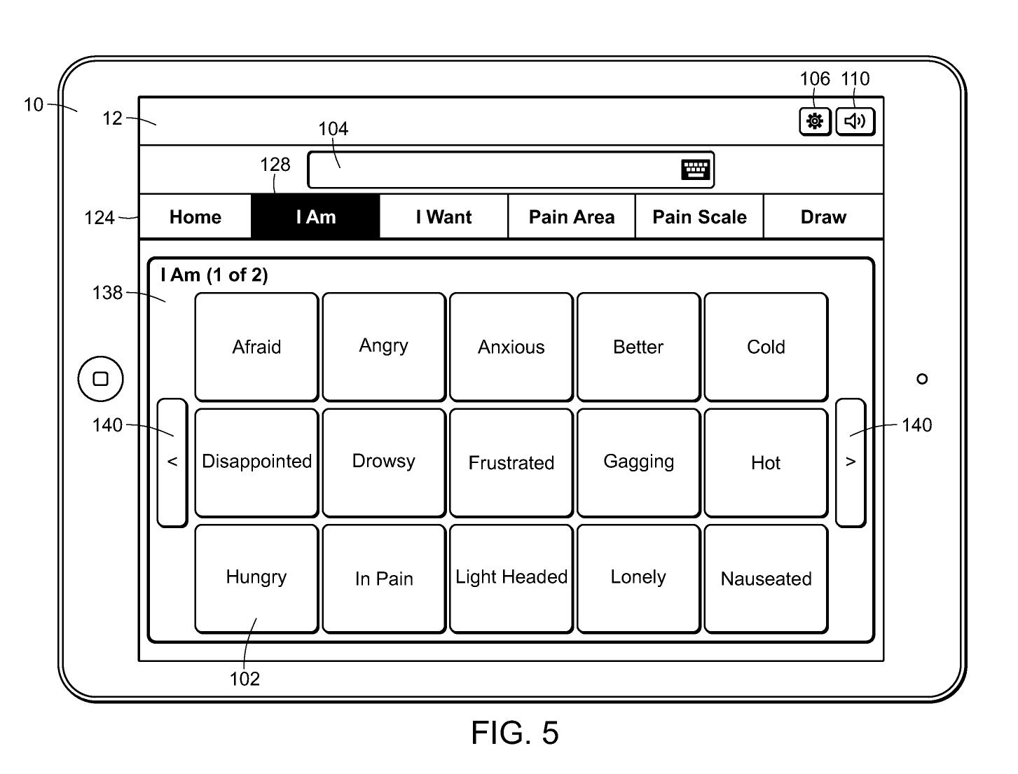

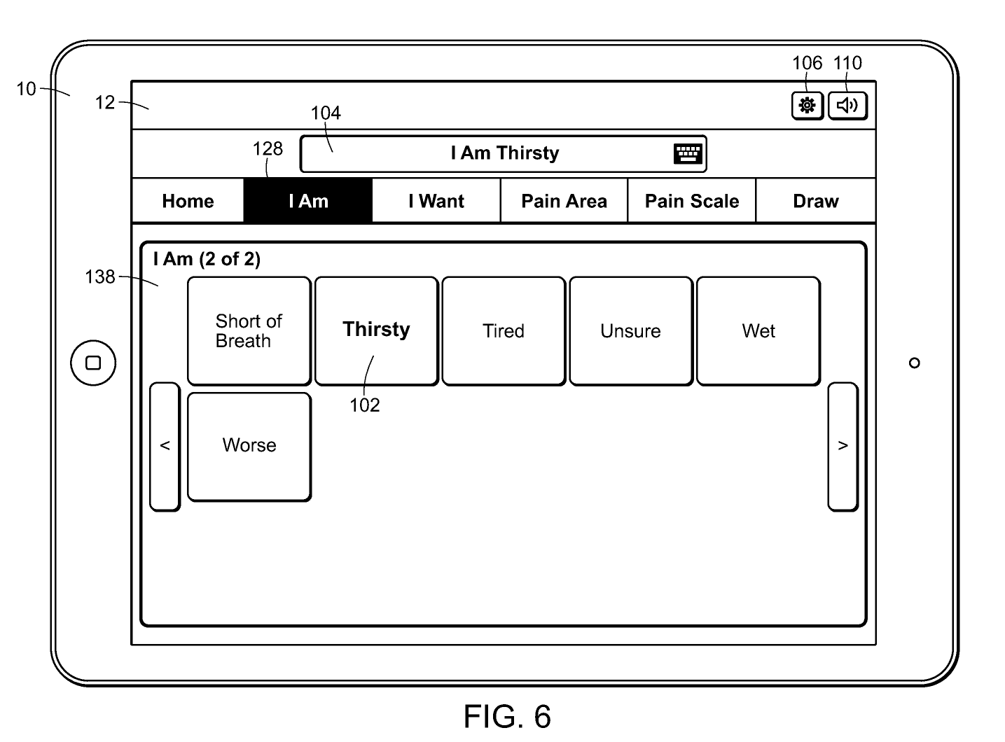

With reference now to FIGS. 5 and 6, when selecting the general patient condition navigation icon of “I Am” 128, one or more screens 138 are shown with a plurality of selectable objects 102 relating to more specific patient conditions. In the illustrated example, there are two pages of the screen 138, which can be toggled back and forth using, for example, directional arrow 140, which will display each page of the screen. With reference now to FIG. 6, when the object 102 for “Thirsty” is selected, the phrase “I am thirsty” is automatically generated and displayed in text box 104 and audibly spoken through the speaker 14.

Common patient conditions are predetermined and displayed in connection with the general patient condition link icon 128, represented herein as “I Am”. These include, for example, “Afraid”, “Angry”, “Anxious”, “Better”, “Cold”, “Disappointed”, “Drowsy”, “Frustrated”, “Gagging”, “Hot”, “Hungry”, “In Pain”, “Light Headed”, “Lonely”, “Nauseated”, “Short of Breath”, “Thirsty”, “Tired”, “Unsure”, “Wet”, and “Worse”. It will be appreciated that the number of objects 102 representing the more specific patient condition can be altered upon the needs of the invention. These may also be arranged in a variety of ways, such as alphabetically, as illustrated in FIGS. 5 and 6, or by common condition, such that the more specific patient conditions of “Hungry” and “Thirsty” would be adjacent to one another. Of course, instead of being presented in word or short phrase form, the objects 102 could be presented in image form, as described above.

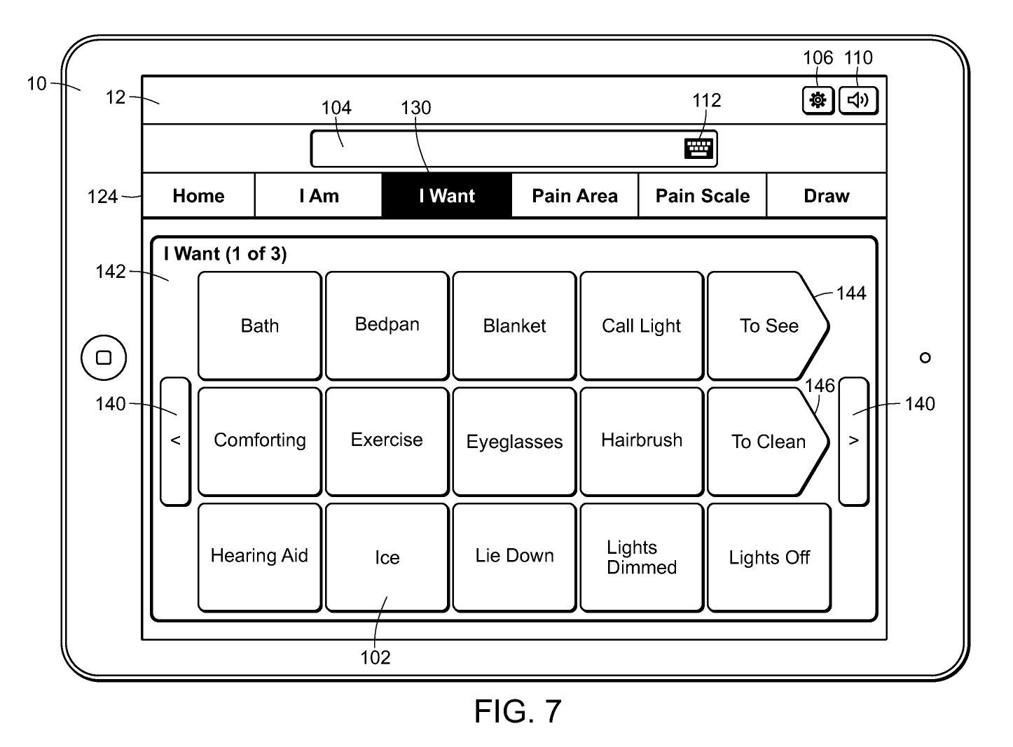

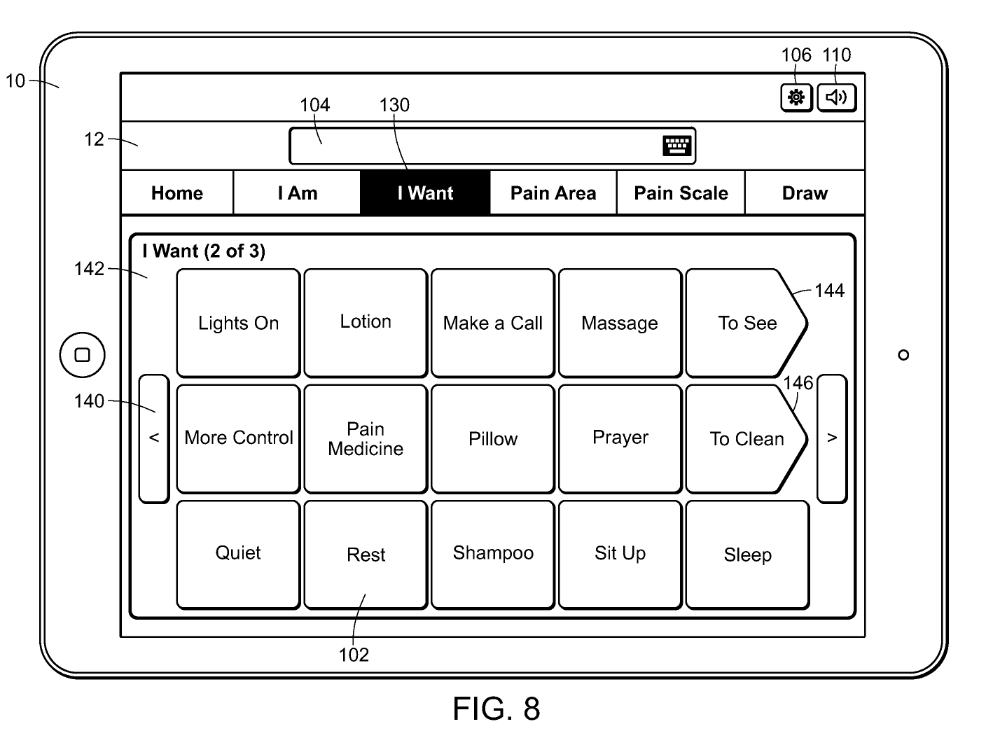

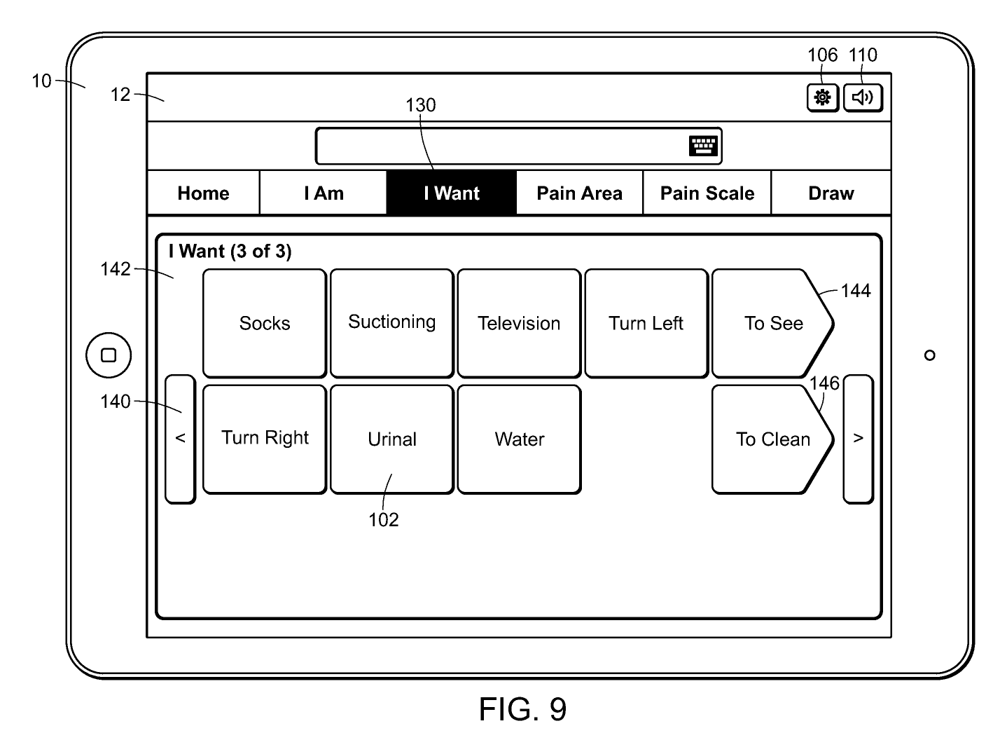

With reference now to FIGS. 7-9, although the navigation icon bar 124 can be only shown in connection with the home page 100, typically the navigation link bar 124 will be presented on a variety of screens, if not all of the screens, to facilitate navigation between the various screens of the invention.

When selecting the general patient desire icon 130 of “I Want”, a screen 142 having one or more pages, as illustrated three pages, of selectable objects representing more specific patient desires is provided. These may include, by way of example but not limitation, “Bath”, “Bedpan”, “Blanket”, “Call Light”, “Comforting”, “Exercise”, “Eyeglasses”, “Hair Brush”, “Hearing Aid”, “Ice”, “Lie Down”, “Lights Dimmed”, “Lights Off”, “Lights On”, “Lotion”, “Make a Call”, “Massage”, “More Control”, “Pain Medicine”, “Pillow”, “Prayer”, “Quiet”, “Rest”, “Shampoo”, “Sit Up”, “Sleep”, “Socks”, “Suctioning”, “Television”, “Turn Left”, “Turn Right”, “Urinal” and “Water”. The various pages of this screen 142 can be navigated by pressing or selecting arrow bar 140 such that the patient can find the more specific patient desire or want represented by the object which can be selected, and a phrase or sentence generated textually and/or audibly, as described above. Thus, for example, if the patient were to select the icon 102 on screen 142 representing “Ice”, the phrase or sentence “I want ice” would be generated in text box 104 and/or transmitted audibly through speaker 14.

As shown in FIGS. 7-9, the screen 142 may also include what is referred to herein as linking objects 144 and 146 which link the general condition or desire of the patient, in this case “I Want” with a subcategory of more specific patient condition or desire linked to the word or phrase of the linking object 144 or 146.

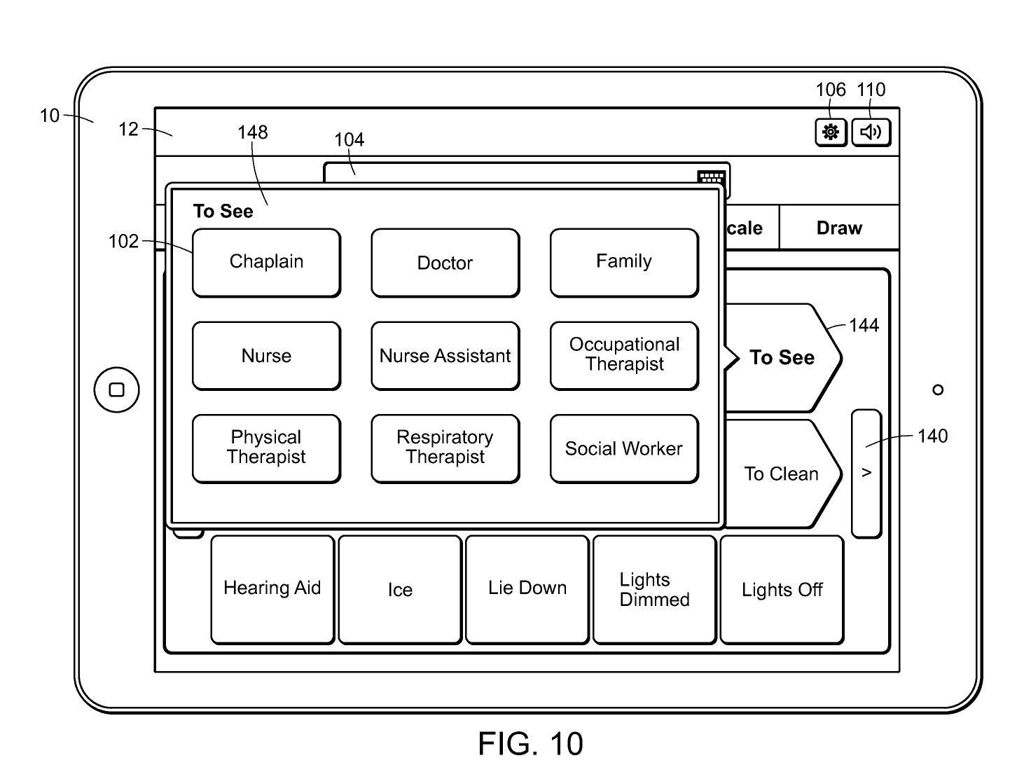

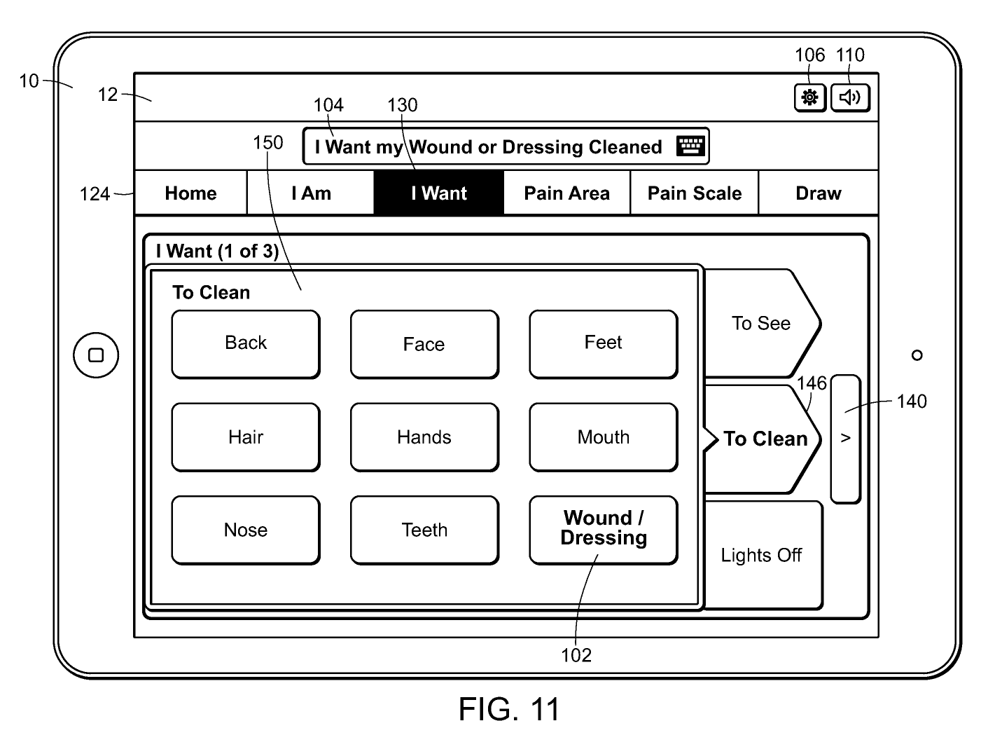

With reference now to FIG. 10, for example, when selecting the linking object 144 “To See”, a window 148 pops up with a plurality of objects 102 corresponding with the linking object 144 “To See” and the general patient desire icon 130 of “I Want”. Thus, for example, if the patient wants to see a chaplain or religious figure, the patient can select the linking icon “I Want” (130) from the navigation icon bar 124, followed by the liking object “To See” (144) followed by the specific object “Chaplain” (102) in window 148. A corresponding phrase or sentence will be automatically generated by the computer program and visually displayed in the text box 104 and/or transmitted audibly through the speaker 14. This is illustrated in FIG. 11, wherein after selecting the “I Want” icon 130 from the navigation bar 124, and selecting the “To Clean” linking object 146, window 150 appears providing a plurality of specific objects relating to the linking object 146 and general patient desire 130, where the patient can select, for example, “Wound/Dressing” object 102, which will result in the phrase or sentence “I want my wound or dressing cleaned” to be generated and placed visually within text box 104 and/or transmitted audibly through the speaker 14. This will communicate to the caregiver, such as the doctor, nurse, friend, family, etc., that the patient would like his or her wound or dressing cleaned.

When selecting the “Pain Area” icon link 132 of navigation bar 124, a screen 152 is displayed having one or more graphical images 154 and 156 representing a human body. Typically, a front of the human body 154 as well as a back view 156 of the human body is illustrated so that the patient can select from the various body parts represented in each graphical body illustration 154 and 156. Depending upon the “Sex” selection in the settings menu, described above, there may be anatomical differences in the human body graphic representations 154 and 156. Alternatively, the human body graphical representations are gender neutral.

A human body part may be selected, such as by touching the touchscreen overlying the body part, using a mouse, joystick, etc. to select the body part, etc. The invention may highlight or mark the selected body part, such as by the illustrated “X” 158 showing that the right arm of the patient has been selected.

Preferably, one or more selectable objects 102 are also provided on screen 152 which correspond to and represent common body ailments. These may be, for example, but not by way of limitation, “Aches”, “Burns”, “Can't Move”, “Cramps”, “Hurts”, “Itches”, “Is Numb”, “Is Tender”, “Stings” and “Is Stiff”. These may be represented by words or truncated phrases, or by graphical images. Moreover, the number and selection of these common body ailments may be varied.

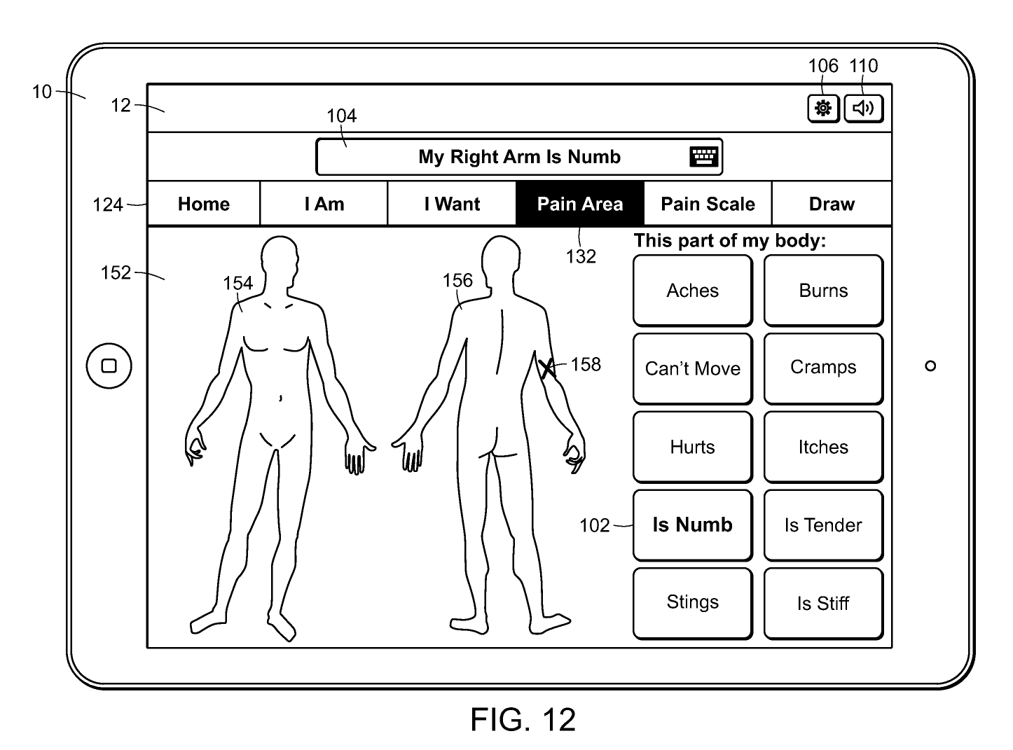

With continuing reference to FIG. 12, when a patient selects the “Pain Area” linking icon 132, and is presented with screen 152, the patient may select a body part, such as the illustrated right arm, as well as selecting an object 102, representing a common body ailment, and the computer program of the present invention will automatically generate a phrase or sentence corresponding with the selections, such as the illustrated “My right arm is numb” and visually display this in text box 104 and/or audibly transmit this phrase or sentence through speaker 14 to communicate the patient's condition or ailment of that particular body part to the patient's caregivers.

It is also contemplated by the present invention that when a patient selects a portion of a body or a body part, that in addition to a visual queue 158 placed on the body so as to ensure that the particular portion of the body has been correctly requested, that touching a portion of the body a new image will appear which is larger and/or in more detail. For example, when touching the head or face of the body, an enlarged face may appear which provides the patient's mouth, nose, ears, etc. so as to enable the patient to more easily select those specific body parts.

As described above, this screen and the related objects and the automatically generated texts and/or speech may be shown and performed in a selected language or in multiple languages so that the patient as well as the healthcare provider will be able to understand the phrase or request or notification so as to eliminate any misunderstandings or miscommunication.

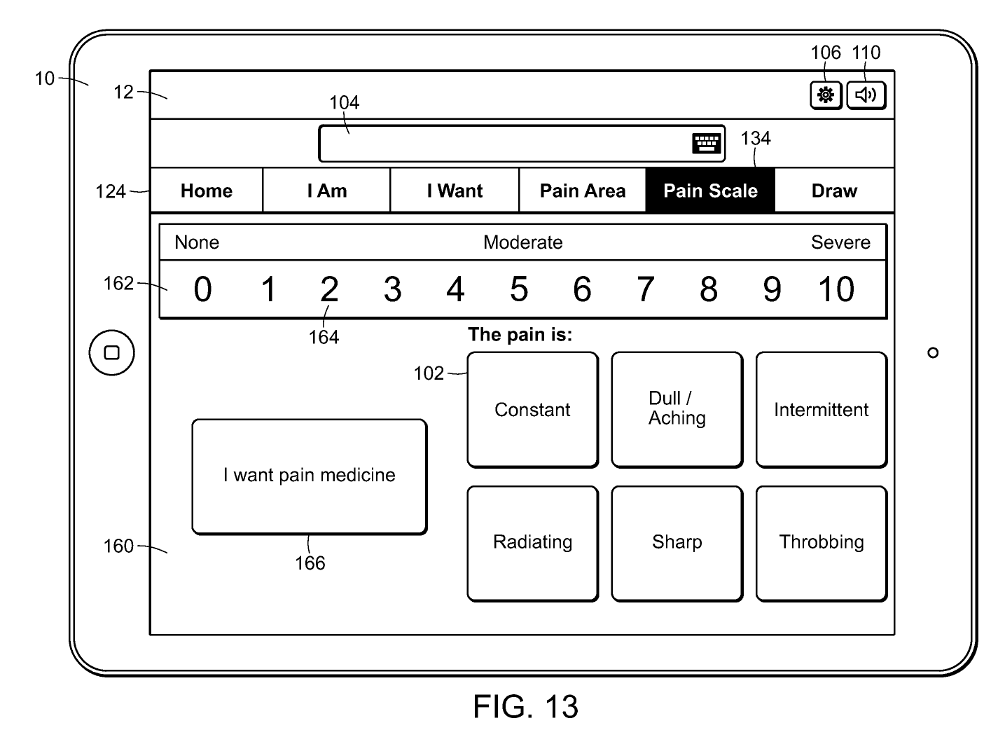

When the linking icon “Pain Scale” 134 is selected from the navigation bar 124, a screen 160 is displayed with a pain scale 162 having a selectable range of patient pain indicia. This may be in the form of a pain scale illustrated in FIG. 13, which uses a numerical pain scale from zero to ten representing no pain to severe pain. The patient would be able to select one of the numerical indicia to communicate the patient's level of pain at that moment to the caregiver and others. This could be visually represented and/or audibly transmitted in a phrase or sentence, such as, for example, “My pain is five or moderate”. The selection of a different pain scale indicia 164 could generate a different phrase or sentence corresponding with the patient's pain.

Moreover, a plurality of pain state related selectable objects 102 could be provided in association with the pain scale 162 so as to further clarify the patient's pain. Such selectable pain state objects could comprise, for example, “Constant”, “Dull/Aching”, “Intermittent”, “Radiating”, “Sharp”, and “Throbbing” so as to further describe and define the type of pain that the patient is experiencing to the caregiver. Such word or phrase corresponding to the pain state could be generated as its own phrase or sentence which would be visually displayed and/or audibly transmitted, or a phrase or sentence could be generated given the combination of the selected indicia 164 of the pain scale 162 and the object 102 corresponding to the pain state of the patient. Thus, for example, the patient may select indicia number two 164 on the pain scale as well as pain state object “Constant” 102, and a phrase to the effect of “My pain is low, a two on a scale of zero to ten, and the pain is constant”. This could be visually represented in the text box 104 and/or audibly transmitted through the speaker 14. A selectable object 166 indicating “I want pain medicine” could also be provided on this screen 160, and possibly on other screens, such as the home page 100.

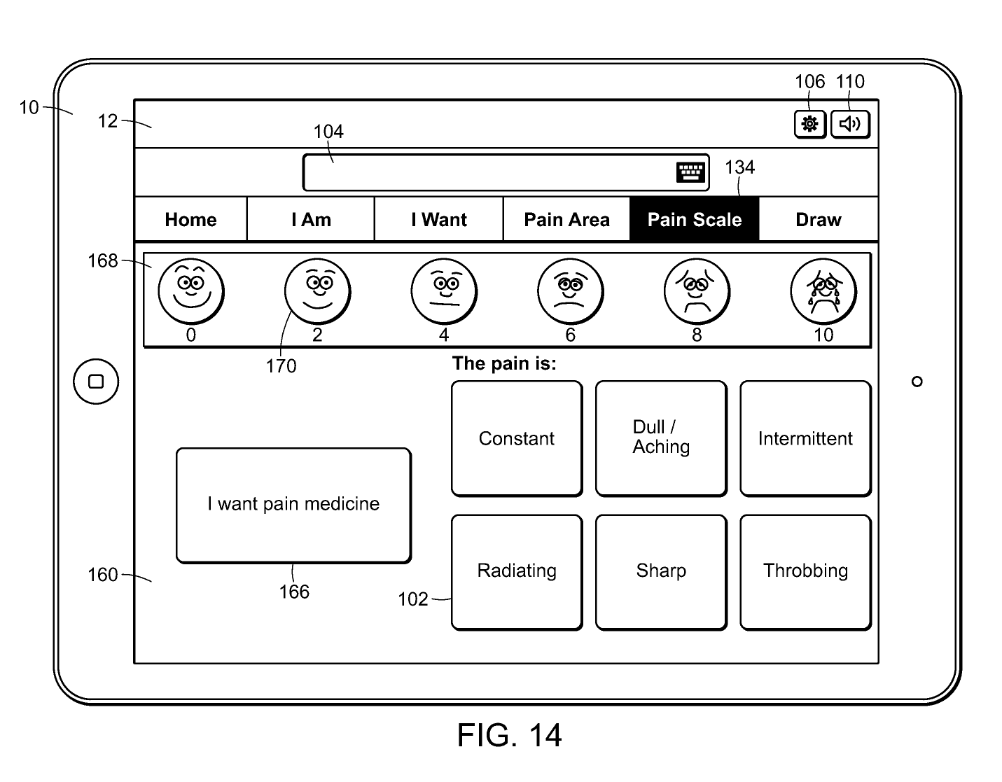

With reference now to FIG. 14, the invention contemplates offering multiple pain scales, which can be selected, for example, in the settings menu 108. This would enable the patient to select the pain scale which the patient readily understands and/or believes would accurately convey the patient's pain to the caregiver. For example, a more graphical pain scale 168 may be provided having graphical images 170 as the indicia representing the patient's pain, as illustrated in FIG. 14. Such a pain scale could comprise the Wong-Baker™ pain scale with graphical representation indicial 170 of a smiley face representing no pain to a sad and crying face representing severe pain. This may be more helpful, for example, for patients who do not read or comprehend traditional numerical pain scales, etc. The pain scale would operate in the same manner illustrated in FIG. 13 where the patient could select merely an indicia from the pain scale 168 and/or an object relating to the pain state or type of pain of the patient.

It will be appreciated that different pain scales could be incorporated into the present invention. These pain scales could be represented as color gradients and modifiable pictorial end points illustrating “most likeable” and “least likeable” icons. For example, these could be very useful for children who may have difficulty conveying pain in terms of numbers or smiling and frowning faces and would rather describe their pain using shades of color or likable versus unlikable icons or characters. For example, Mickey Mouse may be on one end of the spectrum illustrating no pain, with the Tasmanian Devil on the opposite end of the pain scale illustrating the worst pain. Alternatively, for example, pictures of pizza on one end versus Brussels sprouts on the end may serve as another example of an atypical pain scale that could be incorporated into the present invention to facilitate communication between the patient and the caregiver.

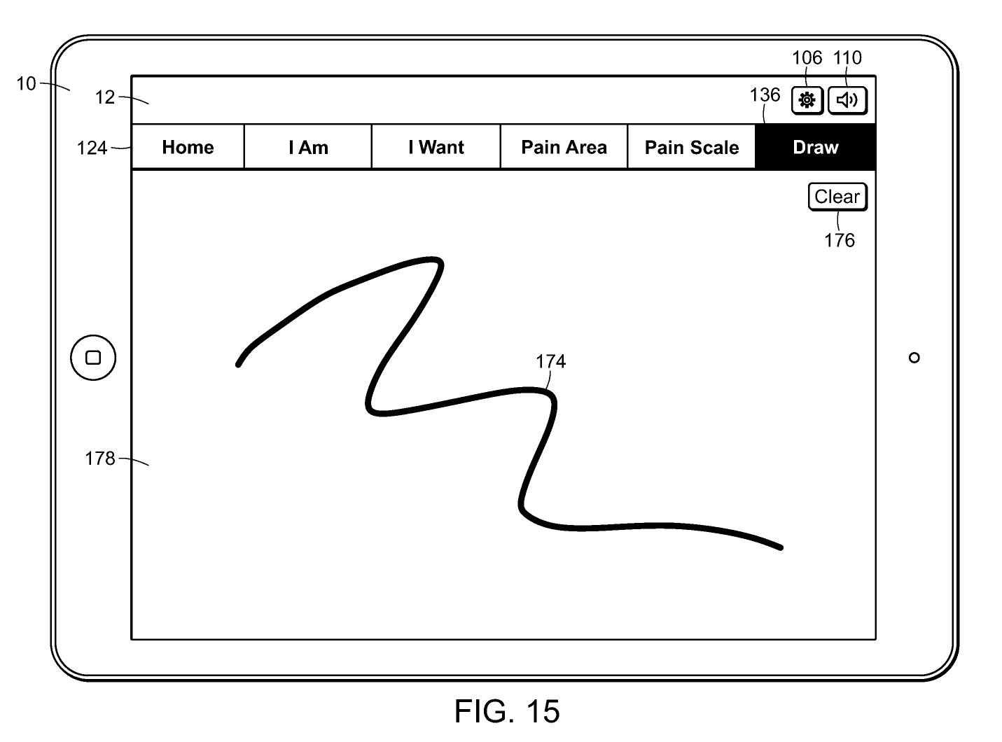

With reference now to FIG. 15, the present invention contemplates the incorporation of a “draw screen”, which can be accessed by selecting linking icon 136 “Draw” of the navigation bar 124, which will present at least a portion of a screen 172 which enables the patient to write or create illustrations in freestyle form, such as using the patient's finger, stylus, a mouse, joystick, etc. In the case of a touchscreen, the patient can merely place his or her finger and write a word or phrase, create an illustration or image or the like. This can enable the patient to simply and easily use the draw screen 172 for personalized requests and statements. A “Clear” button 176 may be used to clear the freestyle writing and/or image previously created, and create a blank screen.

It will also be understood that the present invention may display communication icons in alphabetical order for ease of searching and identifying the searchable word/phrase, which is listed or not listed within the selected category. The invention may also collect usage data and display most commonly used phrases in a separate category displaying the most frequently used selections. Another method that the present invention may use to display the most frequently used communication icons is to display them within their category in order by frequency if the application has been used a sufficiently long period of time. In this manner, the invention may provide a function for the user to orient the words and phrases within a category to be displayed by frequency. Furthermore, the orientation may be updated by reselecting this orientation icon or another icon that refers to update orientation by most frequent. It is also contemplated that the user could move the arrangement of the icons or words or phrases to an order, which is appealing to that user.

Although several embodiments have been described in detail for purposes of illustration, various modifications may be made without departing from the scope and spirit of the invention. Accordingly, the invention is not to be limited, except as by the appended claims.

What is claimed is:

1. A system for facilitating communication with communication-vulnerable patients, comprising:
a computer program providing a graphical user interface having objects relating to predetermined patient conditions and desires;
a computer having non-transitory memory for storing the computer program and a processor for operating the computer program;
an electronic display operably connected to the computer;
means for the patient to electronically select an object on the display, wherein a word, phrase or sentence corresponding to the selected object is generated and audibly transmitted through a speaker to communicate the patient's selection.

2. The system of claim 1, wherein the electronic display comprises a touchscreen.

3. The system of claim 1, wherein the computer and electronic display comprise a hand-held electronic tablet or smartphone.

4. The system of claim 1, wherein the means for electronically selecting an object comprises a touchscreen, electronic remote control device, keyboard, toggle switch, finger pad, stylus, or eye gaze technology.

5. The system of claim 1, wherein the computer program includes an algorithm that automatically creates a sentence or phrase relating to an object selected by the patient.

6. The system of claim 1, wherein the computer program enables the user to modify the content of the objects or the arrangement or order in which the objects are displayed.

7. The system of claim 1 wherein the computer program imports new or updated objects from a remote electronic source.

8. The system of claim 1, wherein the computer program enables language selection, whereby objects containing words and text generated are displayed and/or audibly transmitted in the selected language.

9. The system of claim 8, wherein the computer program enables a second language selection, whereby words or phrases generated corresponding to a selected object are displayed and audibly transmitted in the selected two different languages.

10. The system of claim 1, wherein the computer program is configured to display selectable objects relating to common patient responses to caregiver queries, patient conditions, patient desires and patient questions to caregivers.

11. The system of claim 1, wherein the selectable objects displayed can be selectively altered manually or automatically based on commonly used objects by the patient over time.

12. The system of claim 1, wherein the computer program is configured to provide a plurality of link icons representing general patient conditions or desires, the selection of a link icon resulting in the display of one or more pages of selectable objects relating to more specific patient conditions or desires relating to the general patient condition or desire selected link icon.

13. The system of claim 12, wherein the link icons comprise buttons having the patient conditions and desires of “I am”, “I want”, “Pain Area”, and “Pain Scale”.

14. The system of claim 1, wherein the computer program provides a page having a graphical representation of a human body with selectable body parts and selectable objects representing common body ailments.

15. The system of claim 14, wherein the computer program is configured to generate and visually display and/or audibly transmit a phrase or sentence corresponding to the selected body part and ailment object.

16. The system of claim 1, wherein the computer program is configured to provide a pain scale having a selectable range of patient pain indicia.

17. The system of claim 16, wherein the computer program is configured to provide a plurality of pain state related selectable objects and a selectable request for pain medication in connection with the pain scale.

18. The system of claim 1, wherein the computer program is configured to provide at least a portion of a page that enables the patient to write or draw using the patient's finger, hand-held object, finger pad, computer mouse, switch toggle or eye gaze technology.

19. The system of claim 1, wherein the computer program is configured to display an electronic keyboard and selectable objects representing commonly used words or phrases to begin a sentence, and a text box in which the phrase or sentence generated by the selection of the objects and/or keys of the keyboard is visually displayed.

20. The system of claim 19, wherein the computer program includes a text to speech generator algorithm for transmitting the phrase or sentence generated in the text box audibly through the speaker.

21. The system of claim 20, wherein the computer program includes a text to speech generator algorithm for transmitting the phrase or sentence generated in the text box in two different languages, providing bilingual communication in text format and/or audible voice.

22. A non-transitory computer-readable medium for facilitating communication with a communication-vulnerable patient, comprising instructions stored thereon, that when executed on a processor, performs the steps of:
displaying on an electronic display a predetermined plurality of electronically selectable objects in the form of images and/or words or phrases representing patient conditions and/or desires;
generating an audio file comprising a word or phrase corresponding to a selected object; and
audibly transmitting through a speaker the word or phrase corresponding to the selected object.

23. The computer-readable medium of claim 22, including the step of automatically generating a sentence or phrase corresponding to an object selected by the patient and visually displaying the sentence or phrase on the electronic display and transmitting the sentence or phrase through the speaker.

24. The computer-readable medium of claim 22, including the step of providing a selection of languages and displaying the objects in the selected language.

25. The computer-readable medium of claim 24, including the step of transmitting the word or phrase corresponding to the selected object through the speaker in the selected language.

26. The computer-readable medium of claim 25, including the step of automatically generating a phrase or sentence corresponding to the selected object in the selected language and displaying the word or phrase on the electronic display.

27. The computer-readable medium of claim 26, including the step of selecting a second language and transmitting the word or phrase corresponding to the selected object in the two different selected languages and/or visually displaying the word or phrase in the two different languages on the electronic display.

28. The computer-readable medium of claim 22, including the step of displaying a plurality of link icons representing general patient conditions or desires, the selection of a link icon automatically linking to at least one electronic page having a plurality of objects relating to the general patient condition or desire of the selected link icon.

29. The computer-readable medium of claim 22, including the step of displaying selectable objects representing common patient conditions, desires, responses to caregiver queries, and/or patient to caregiver queries.

30. The computer-readable medium of claim 22, including the step of displaying an image of a human body with electronically selectable body parts and a plurality of objects representing common body ailments.

31. The computer-readable medium of claim 29, including the step of generating a phrase or sentence when a body part and/or body ailment object are selected and generating a phrase or sentence corresponding to the selected body part and/or body ailment object and audibly transmitting the generated phrase or sentence corresponding to the selected body part and body ailment object through the speaker.

32. The computer-readable medium of claim 30, including the step of visually displaying on the electronic display the generated phrase or sentence corresponding to the selected body part and/or body ailment.

33. The computer-readable medium of claim 22, including the step of displaying a pain scale having a range of patient pain indicia.

34. The computer-readable medium of claim 32, including the step of displaying in association with the pain scale a plurality of pain state related objects and a request for pain medication.
